(19) United States
(12) Patent Application Publication
(10) Pub. No.: US 2005/0254677 A1
(43) Pub. Date: Nov. 17, 2005

(54) Hearing aid having a display device

(75) Inventor: Jurgen Reithinger, Nurnberg (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Audiologische Technik GmbH

(21) Appl. No.: 11/126,095

(22) Filed: May 10, 2005

(30) Foreign Application Priority Data
May 11, 2004 (DE) 10 2004 023 047.1

(51) Int. Cl. H04R 25/00

(52) U.S. Cl. 381/322; 381/312

(57) ABSTRACT

The display of status information on a hearing aid is to be improved. To this end, provision is made for the display device (A) to be embodied on the housing of a hearing aid (I) as an electrophoretic display. This is very flexible and thin and can thus be applied in any form to almost any position on the hearing aid. In addition the electrophoretic display (A) only requires energy to change the information displayed. This enables the energy consumption required for a hearing aid display to be greatly reduced.

### CROSS REFERENCE TO RELATED APPLICATIONS

This application claims priority to the German application No. 10 2004 023 047.1, filed May 11, 2004 which is incorporated by reference herein in its entirety.

### FIELD OF INVENTION

The present invention relates to a hearing aid with a display device for displaying status information. In addition the present invention relates to a method for operating a hearing aid by displaying this type of status information.

### BACKGROUND OF INVENTION

Hearing aids currently usually only provide audible feedback. Such audible feedback only allows checks to be made, as to whether the hearing aid is switched on for example, once it is has been put on by the wearer. It may also be possible to see the status from the on/off switch, provided the device has one. Checking the state of the battery is also not a straightforward matter. To do this the device must have been worn for a long period to enable the audible message for a low battery to be heard. Establishing the state of the battery when the device is not currently being worn is not possible as a rule.

### SUMMARY OF INVENTION

It has thus been proposed to display the battery state, the selected program and further information for the wearer and for third parties directly on the device through a display. In particular the Swiss company Eurion offers a hearing aid with an LCD display (www.eurion.ch/Dt/Default.htm). However this display requires a great deal of space and also a comparatively large current. Both are naturally in short supply with hearing aids. Thus it is hardly possible to implement displays, particularly for in-ear hearing aids.

In addition electrophoretic and electrochrome displays are known on the electronics market. Electrochrome displays are based on the electrochrome effect which occurs in many organic materials. It consists of changing the absorption or reflection characteristics of a material as a result of a reversible oxidation or reduction. Electrophoretic displays are based on the effect of aligning or shifting electrically charged particles in the electrical field and thereby creating different contrasts. The best-known forms of implementation for such displays are what are known as “electronic paper” and the “electronic ink”. This means that the display is extremely flexible and light and looks like printed paper. In the form of ink it can be applied in any form to a carrier (Helmuth Lemme, “Displays zum Aufrollen” (Displays that you can roll up), Elektronik 16/2003, pages 56 to 61).

An alarm device is known from DE 35 45 088 A1 which is included as part of an ear insert which can be introduced into the auditory canal. This ear insert can contain hearing aid components and features a display device on which the alarm time set can be read out. A quartz watch display can be used as a display.

An object of the present invention is to further improve the options for presenting status information on a hearing aid.

In accordance with the invention this object is achieved by the claims.

The advantage of the electrophoretic displays compared to LCD displays is that the electrophoretic displays are not as rigid and voluminous as the LCD displays. In addition the LCD displays permanently require current while they are displaying data, whereas the electrophoretic displays only briefly require energy to change the information displayed. After the information has been changed the display will then retain the information displayed without any energy being fed to it. Since these displays do not consume any current provided the displayed data is not changed it is also possible to dispense with elements which activate the display. This contributes to further space savings.

Since the electrophoretic displays, as already mentioned, can generally be designed to be very flexible and very thin, this also makes it very simple to provide curved, rounded parts of the housing of a hearing aid with a display. This increases the flexibility of the positioning of displays, which in particular allows for of the lack of space available with hearing aids.

In particular it provides the opportunity of gluing the display device onto the hearing aid housing. This assembly step can be implemented comparatively simply.

Furthermore the display device can also be applied to the hearing aid housing with a coating technique. This makes automated application of a wide diversity of forms of display to the hearing aid possible.

The hearing aid with the electrophoretic display can be an in-the-ear hearing aid and especially also a CIC (completely-in-the-canal) hearing aid. Despite the small size of these hearing aids it is possible to use the space-saving and flexible display there.

A particular area of application for electrophoretic displays is also opened up with child's hearing aids which are smaller in size than hearing aids for adults.

The status information which is to be reproduced with the electrophoretic display can relate to the activation status of the hearing aid, the battery charge state, the selected hearing program and/or the volume setting. This enables all important information to be displayed directly to third parties, e.g. the audiologist, on the hearing aid.

### BRIEF DESCRIPTION OF THE DRAWINGS

The invention will now be explained in more detail on the basis of the enclosed drawings, which show:

FIG. 1 a view from above of the outside of an in-the-ear hearing aid and

FIG. 2 a side view of an in-the-ear hearing aid.

The embodiments explained below in greater detail represent preferred exemplary embodiments of the present invention.

### DETAILED DESCRIPTION OF INVENTION

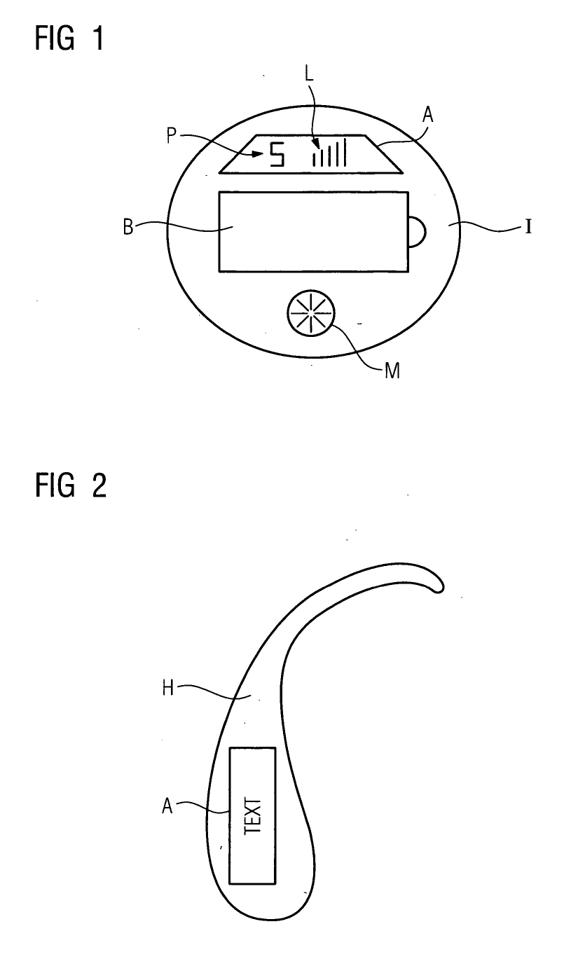

The exterior surface (cf. FIG. 1) of an in-the-ear hearing aid, which points outwards when the hearing aid is inserted in the ear, generally measures only 1 cm². The largest proportion of this outside surface is usually occupied by the battery compartment B. In addition there is also a microphone input M on the outside surface. In accordance with the example shown in FIG. 1 the only space that remains for the display on the exterior surface is an area similar in shape to a circle segment. In this area it is a simple matter in accordance with the invention to accommodate an electrophoretic display A. Since practically no depth is required for such displays, they can be fitted entirely into this space. Since they can further be designed in any shape, the best possible use can be made of the available space. In the case shown a trapezium shape has thus been selected for the display.

Any information about the status of the hearing aid I can be shown on the display A. In the case shown here the hearing aid program P and the volume setting L are shown simultaneously in the electrophoretic display A.

The electrophoretic display also has advantages for behind-the-ear hearing aids. Since its housing is domed practically everywhere, one is no longer limited with the electrophoretic display A to areas of the housing which are almost flat Instead large-area displays can also be implemented on the hearing aid housing, as is depicted in FIG. 2. These types of large-area displays A also allow longer texts to be displayed or more information simultaneously.

With the examples of electrophoretic displays shown in FIGS. 1 and 2 it is possible for example to show on hearing aids I and H whether the relevant device is switched on and whether it still has enough battery power. In addition, as well as the selected hearing program P and the volume L, service information may possibly also be shown. If the display H is not large enough to show all the information, the information can be displayed staged over time, for example displayed for a predetermined period once the display has been changed.

The size of the display is not of any great significance as regards energy consumption. In principle energy will always only be required to change the display.

For provision of hearing aids to children in particular, the display on the child's hearing aid will make it easier for parents to check whether their child's hearing aid is functioning correctly and has the correct settings. But with adult hearing aids too the specific advantage of the invention is that for example the easy-to-read display allows the status of the battery to be checked before the wearer puts the hearing aid on.

1-6. (canceled)

7. A hearing aid, comprising:
a housing for accommodating the hearing aid; and
a display device for displaying status information related to operating the hearing aid, wherein the display device is an electrophoretic display.

8. The hearing aid in accordance with claim 7, wherein the display device is glued to the housing.

9. The hearing aid in accordance with claim 7, wherein the display device is applied to the housing using a coating technique.

10. The hearing aid in accordance with claim 7, wherein the hearing aid is an In-The-Ear hearing aid.

11. The hearing aid in accordance with claim 10, wherein the hearing aid is a CIC hearing aid.

12. The hearing aid in accordance with claim 7, wherein the hearing aid is a child's hearing aid.

13. The hearing aid in accordance with claim 7, wherein the status information includes an element chosen from the group consisting of an activation status, a battery charging state, a hearing program selection and a volume setting, of the hearing aid.
